(19) United States
(12) Patent Application Publication
(10) Pub. No.: US 2021/0304171 A1
(43) Pub. Date: Sep. 30, 2021

(54) INFORMATION PROCESSING APPARATUS, INFORMATION PROCESSING SYSTEM, AND INFORMATION PROCESSING METHOD FOR AN INFORMATION PROCESSING APPARATUS

(71) Applicant: TOSHIBA TEC KABUSHIKI KAISHA, Tokyo (JP)

(72) Inventor: Misako KOFUJI, Mishima Shizuoka (JP)

(21) Appl. No.: 17/144,712

(22) Filed: Jan. 8, 2021

(30) Foreign Application Priority Data
Mar. 24, 2020 (JP) 2020-053015

(51) Int. Cl. G06Q 20/20; G07G 1/00; G07G 1/14

(52) U.S. Cl. CPC G06Q 20/202; G07G 1/14; G07G 1/0009; G06Q 20/208

(57) ABSTRACT

According to an embodiment, an information processing apparatus monitors operating states of a plurality of commodity sales data processing apparatuses. When an anomaly has occurred in any one of the plurality of commodity sales data processing apparatuses, the information processing apparatus determines whether or not another one of the plurality of commodity sales data processing apparatuses is capable of executing at least a process being executed by the commodity sales data processing apparatus in which the anomaly has occurred. The information processing apparatus transmits, on the basis of a result of the determination, information for guiding a customer to the other commodity sales data processing apparatus that is capable of executing the process being executed and serves as an alternative device, to the commodity sales data processing apparatus in which the anomaly has occurred.

### CROSS-REFERENCE TO RELATED APPLICATIONS

This application is based upon and claims the benefit of priority from the prior Japanese Patent Application No. 2020-053015, filed on Mar. 24, 2020, the entire contents of which are incorporated herein by reference.

### FIELD

An embodiment described herein generally relates to an information processing apparatus, an information processing system, and an information processing method for an information processing apparatus.

### BACKGROUND

From the past, there has been known a point-of-sale (POS) system in which, when a POS terminal has a failure, its display control is performed by another POS terminal instead.

In the above-mentioned POS system, however, the display control can be taken over from the POS terminal in which a failure has occurred to another POS terminal, but commodity sales data processes such as a registration process and a settlement process have been hardly taken over.

### BRIEF DESCRIPTION OF THE DRAWINGS

FIG. 1 is a block diagram of an example of a monitoring system according to an embodiment.

FIG. 2 is an external view of an example of a self-POS terminal according to the embodiment.

FIG. 3 is a block diagram of an example of a hardware configuration of the self-POS terminal according to the embodiment.

FIG. 4 is a block diagram of an example of a hardware configuration of a store server according to the embodiment.

FIG. 5 is a block diagram of an example of a functional configuration of the monitoring system according to the embodiment.

FIG. 6 is a diagram of an example of a correspondence relationship between a process executed by the self-POS terminal and a functional part of the self-POS terminal monitored by the store server in accordance with the process executed by the self-POS terminal in the embodiment.

FIG. 7 is a diagram of an example of a screen on which a customer designates a condition when the customer performs a settlement process by the self-POS terminal according to the embodiment.

FIG. 8 is a diagram of an example of an alternative device guidance screen according to the embodiment.

FIG. 9 is a diagram of another example of the alternative device guidance screen according to the embodiment.

FIG. 10 is a flowchart showing an example of a process performed by the store server according to the embodiment.

FIG. 11 is a flowchart showing an example of a process performed by the self-POS terminal according to the embodiment.

### DETAILED DESCRIPTION

According to one embodiment, an information processing apparatus monitors operating states of a plurality of commodity sales data processing apparatuses, each of the plurality of commodity sales data processing apparatuses performing a plurality of processes on the basis of data of a commodity to be purchased, the data being to be input by a customer. The information processing apparatus includes a communication interface, a storage device, and a controller. The communication interface communicates with the plurality of commodity sales data processing apparatuses. The storage device stores a correspondence relationship between each of the plurality of processes executed by each of the plurality of commodity sales data processing apparatuses and a functional part to be monitored of a corresponding one of the plurality of commodity sales data processing apparatuses, the functional part corresponding to each of the plurality of processes. The controller acquires information of the plurality of processes being executed by the plurality of commodity sales data processing apparatuses and information of operating states of the functional parts from the plurality of commodity sales data processing apparatuses via the communication interface. The controller monitors the acquired operating states of the functional parts of the plurality of commodity sales data processing apparatuses in accordance with the correspondence relationship stored in the storage device. The controller determines, when determining that an anomaly has occurred in one of the plurality of commodity sales data processing apparatuses on the basis of a result of the monitoring, whether or not another one of the plurality of commodity sales data processing apparatuses is capable of executing at least a process being executed by the commodity sales data processing apparatus in which the anomaly has occurred, further on the basis of the result of the monitoring. The controller transmits, on the basis of a result of the determination, information for guiding the customer to the other commodity sales data processing apparatus that is capable of executing the process being executed and serves as an alternative device, to the commodity sales data processing apparatus in which the anomaly has occurred, via the communication interface.

An embodiment will be described with reference to the drawings. In the figures, the same reference symbol represents the same or similar portion. Hereinafter, a monitoring system will be described as an embodiment. The monitoring system monitors operating states of a plurality of self-POS terminals in a retail store such as a convenience store, a supermarket, or the like. The monitoring system has a function of guiding a customer to another self-POS terminal capable of taking over the process of a self-POS terminal being used by the customer when an anomaly such as a failure occurs in that self-POS terminal.

### System Configuration of Monitoring System

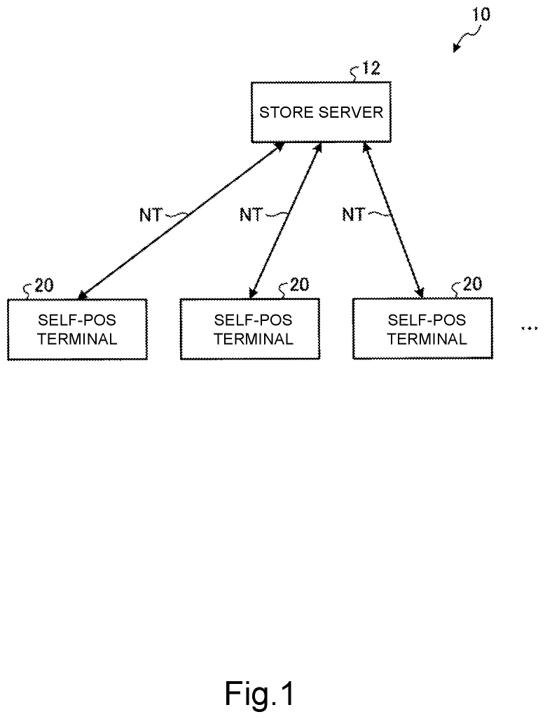

FIG. 1 is a block diagram of an example of the monitoring system according to the embodiment.

A monitoring system 10 includes a store server 12 and a plurality of self-POS terminals 20 installed in a store. The monitoring system 10 monitors the operating states of the plurality of self-POS terminals 20. Note that the monitoring system 10 is an example of an information processing system according to the embodiment.

The store server 12 constantly monitors whether or not anomalies occur in the operating states of the plurality of self-POS terminals 20. Here, the anomalies include a problem in a hardware state of a functional part to be described later. Additionally, the anomalies include a state where the remaining amount of receipt sheets is insufficient when the functional part is a receipt printer to be described later. Additionally, the anomalies include a state where the remaining number of coins for change is insufficient and a state where the remaining number of bills for change is insufficient when the functional part is a cash depositing and dispensing device to be described later. Note that the store server 12 is an example of an information processing apparatus according to the embodiment.

The self-POS terminal 20 is a device with which a customer performs a registration process and a settlement process for a commodity on the basis of an operation of an operator, and is also called a self-checkout device. The plurality of self-POS terminals 20 having the same configuration are installed in the store. Note that the self-POS terminal 20 is an example of a commodity sales data processing apparatus according to the embodiment.

The registration process is a process of registering data of a commodity to be purchased by the customer, by inputting the data to the self-POS terminal 20. More specifically, the self-POS terminal 20 reads a code symbol such as a bar code attached to the commodity, and thus acquires a commodity code for specifying the commodity, which is registered in the code symbol. Here, the code symbol is attached to the commodity. Additionally, the commodity code is identification data for uniquely specifying the commodity. The self-POS terminal 20 then reads the data of the commodity (commodity information such as a commodity name and a price) from a commodity master on the basis of the acquired commodity code. Further, the self-POS terminal 20 notifies the customer of the read data by displaying that data, and also stores the data of the commodity.

The settlement process is performed on the basis of the data of the commodity, which is stored by the registration process of the self-POS terminal 20. Specifically, the settlement process includes a process of displaying a total amount related to a transaction and a tax amount, a process of calculating and displaying the change on the basis of deposit money deposited by the customer, a process of instructing a change machine to issue the change, and a process of issuing a receipt on which the commodity information and settlement data (settlement information such as a total amount, a deposit amount, and a change amount) are printed.

The store server 12 and the self-POS terminal 20 are connected to each other by a communication line NT such as a local area network (LAN) in the store. The store server 12 monitors the operating state of the self-POS terminal 20 and exchanges information with the self-POS terminal 20 via the communication line NT.

The monitoring system 10 according to the embodiment has a function of guiding the customer to another self-POS terminal 20 (alternative device) capable of continuing the process currently performed in the self-POS terminal 20 being used by the customer when the operating state of the self-POS terminal 20 is abnormal.

### Description on Self-POS Terminal

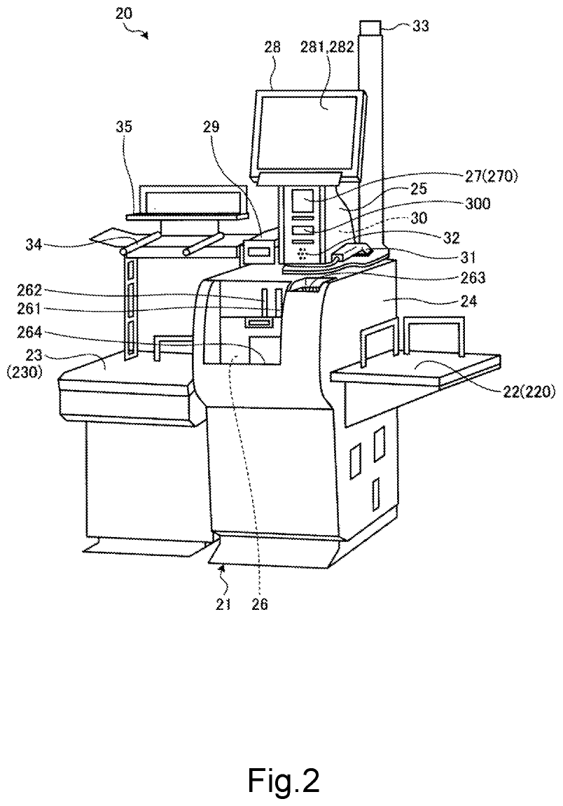

Next, the configuration of the self-POS terminal 20 will be described with reference to FIG. 2. FIG. 2 is an external view of an example of the self-POS terminal 20. The self-POS terminal 20 includes a main body 21, a first placement table 22, and a second placement table 23. The main body 21 is provided between the first placement table 22 and the second placement table 23.

The main body 21 includes a first housing 24, a second housing 25, a cash depositing and dispensing device 26, a fixed scanner 27, a display and operation panel 28, a card reader and writer 29, a receipt printer 30, a handy scanner 31, a speaker 32, and a warning light 33.

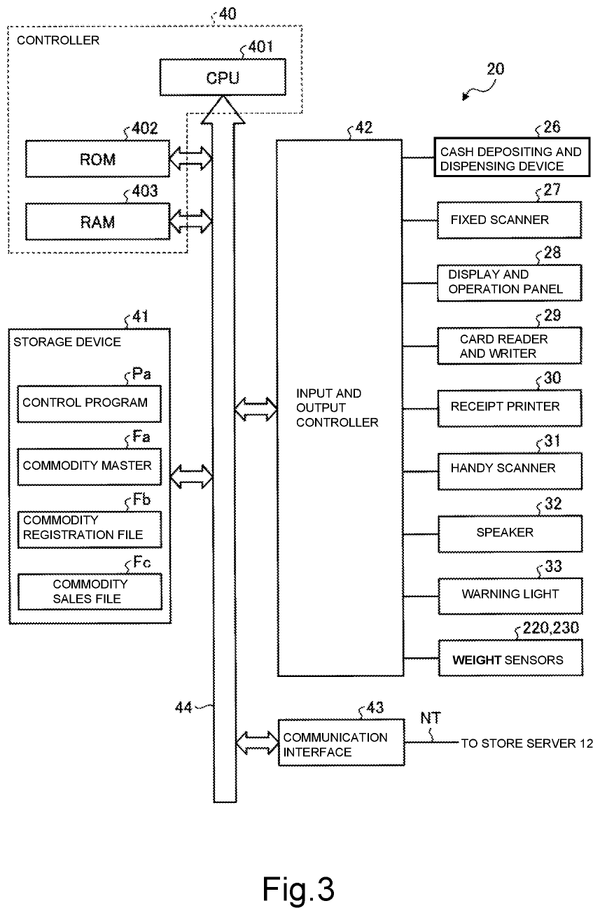

The first housing 24 is formed in a substantially box shape and incorporates a controller 40 (see FIG. 3) to be described later, the cash depositing and dispensing device 26, and the like. The second housing 25 is the outer shell of the fixed scanner 27 and the receipt printer 30 and is provided on the top surface of the first housing 24.

The cash depositing and dispensing device 26 includes a bill depositing port 261, a bill dispensing port 262, a coin depositing port 263, and a coin dispensing port 264. The cash depositing and dispensing device 26 receives bills and/or coins input to the bill depositing port 261 and/or the coin depositing port 263, and separately stores them for each denomination. The cash depositing and dispensing device 26 then uses the stored bills and coins as change to be dispensed from the bill dispensing port 262 and/or the coin dispensing port 264. Additionally, the cash depositing and dispensing device 26 outputs the remaining numbers of coins and bills for change stored therein to the controller 40 via an input and output controller 42 and an internal bus 44.

The fixed scanner 27 includes an imaging window 270 provided at the upper portion of the second housing 25, and an imaging device (not shown) provided at the back of the imaging window 270. When a commodity to be purchased by a customer is registered, the fixed scanner 27 images, by using the imaging device, a code symbol such as a bar code passed in front of the imaging window 270. The fixed scanner 27 then decodes the code symbol captured by the imaging device to obtain a commodity code.

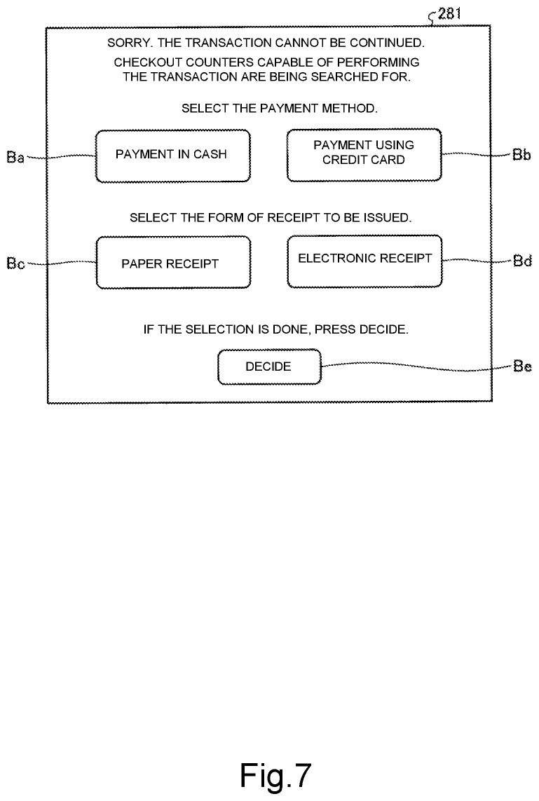

The display and operation panel 28 includes a display device 281 and a touch panel 282 and is attached to the upper portion of the second housing 25. The display device 281 displays various screens in accordance with the instructions of the controller 40. For example, the display device 281 displays a selection screen (see FIG. 7) for selecting a settlement condition to be described later. The touch panel 282 is provided to the display surface of the display device 281 in a stacked manner, and outputs information indicating the position touched by the customer to the controller 40. The controller 40 gives an operating instruction corresponding to the position output from the touch panel 282 to the self-POS terminal 20. For example, the controller 40 acquires the settlement condition through the touch panel 282 of the selection screen, and instructs the communication interface to transmit the acquired settlement condition to the store server 12.

The card reader and writer 29 is disposed on the top surface of the first housing 24. The card reader and writer 29 reads and writes data from and to a card medium. For example, the card reader and writer 29 reads information used for a credit settlement and an electronic settlement from a card medium such as a credit card or an electronic money card of a prepaid type or a deferred payment type, and outputs the information to the controller 40.

The receipt printer 30 includes a print unit (not shown) incorporated in the second housing 25, a storage unit for storing receipt sheets, and a receipt issuing port 300 provided on the front surface of the second housing 25. The receipt printer 30 prints settlement information and the like on a receipt sheet by the print unit. The receipt printer 30 issues the receipt sheet on which the settlement information is printed, as a receipt, from the receipt issuing port 300. Additionally, the receipt printer 30 outputs the remaining amount of the stored receipt sheets to the controller 40 via the input and output controller 42 and the internal bus 44.

The handy scanner 31 is a hand-held scanner. The handy scanner 31 reads the code symbol attached to the commodity when the customer has difficulty of passing the code symbol attached to the commodity over the fixed scanner 27, for example, when the commodity is heavy or large.

The speaker 32 provides information by sound to the customer as necessary, for example, in a case where the display device 281 fails to display information.

The warning light 33 is turned on or flashing in red or the like, for example, to inform a store clerk that an anomaly has occurred in the self-POS terminal 20. Additionally, the warning light 33 informs a store clerk that the customer mistakenly operates the self-POS terminal 20. Further, the warning light 33 informs the customer that the customer is operating an alternative device for the self-POS terminal 20.

The first placement table 22 is a table for placing a basket in which commodities before subjected to registration are put. The first placement table 22 is fixed to a side surface portion of the main body 21. The first placement table 22 includes a weight sensor 220 therein. The second placement table 23 is a table for placing registered commodities, and is installed on the opposite side of the first placement table 22 with the main body 21 interposed therebetween. The second placement table 23 includes a weight sensor 230 therein.

The weight sensor 220 measures the total weight of the commodities to be registered by the customer. The weight sensor 230 measures the total weight of the registered commodities. The weight of a commodity is registered in a commodity master Fa. The self-POS terminal 20 checks whether the weight measured by the weight sensor 230 increases by the weight of a registered commodity when the registered commodity moves to the second placement table 23. Additionally, when the registration of all the commodities is completed, the self-POS terminal 20 confirms that the weight first measured by the weight sensor 220 matches the weight measured by the weight sensor 230 after the registration is completed. This prevents the occurrence of improprieties at the time of registration.

The second placement table 23 includes a hook 34 for hanging a take-out bag for putting the data-registered commodities therein, and a temporary placement table 35 for temporarily placing the data-registered commodities before putting the data-registered commodities in the take-out bag. The temporary placement table 35 is used as a table for temporarily placing commodities such as eggs and breads, which may be damaged or deformed, to be put in the take-out bag last.

### Description on Hardware Configuration of Self-POS Terminal

A hardware configuration of the self-POS terminal 20 will be described with reference to FIG. 3. FIG. 3 is a hardware block diagram showing an example of the hardware configuration of the self-POS terminal.

The self-POS terminal 20 includes the controller 40, a storage device 41, the input and output controller 42, and a communication interface 43.

The controller 40 includes a central processing unit (CPU) 401, a read only memory (ROM) 402, and a random access memory (RAM) 403. The CPU 401 is a control subject. The ROM 402 stores various kinds of fixed data, various tables, and the like. The RAM 403 functions as a work memory for expanding a control program and various kinds of data when the CPU 401 performs various processes.

The storage device 41 stores a control program Pa, the commodity master Fa, a commodity registration file Fb, and a commodity sales file Fc. The storage device 41 is, for example, a hard disk drive (HDD) that holds stored information even when the power is turned off. Additionally, the storage device 41 may include a nonvolatile memory such as a flash memory, instead of the HDD.

The control program Pa is a program executed by the CPU 401. The CPU 401, the ROM 402, the RAM 403, and the storage device 41 are connected to one another via the internal bus 44. The CPU 401 of the controller 40 expands, in the RAM 403, the control program Pa stored in the storage device 41 and various kinds of data stored in the ROM 402 to operate the control program Pa. As a result, the controller 40 executes various control processes performed by the self-POS terminal 20.

The commodity master Fa is a file for storing code information such as a JAN code uniquely assigned to each commodity, and commodity information such as a name, a price, and a commodity classification of the commodity, in association with each other. The commodity registration file Fb is a file for storing commodity information of a commodity registered by the customer. The commodity sales file Fc is a file for storing commodity sales information generated when the self-POS terminal 20 performs a registration process and a settlement process for the commodity.

The input and output controller 42 connects the CPU 401 to the peripheral devices such as the cash depositing and dispensing device 26, the fixed scanner 27, the display and operation panel 28, the card reader and writer 29, the receipt printer 30, the handy scanner 31, the speaker 32, and the weight sensors 220 and 230 via the internal bus 44. The input and output controller 42 controls the operations of those peripheral devices in response to the instructions from the controller 40.

The communication interface 43 connects the self-POS terminal 20 and the store server 12 to each other via the communication line NT. The communication interface 43 communicates with the store server 12 under the control of the controller 40, and transmits and receives various kinds of information. For example, as will be described later, when the store server 12 determines that an anomaly has occurred in the self-POS terminal 20, the communication interface 43 receives anomaly occurrence information and alternative device guidance information from the store server 12. Here, the anomaly occurrence information is information indicating that an anomaly has occurred in the self-POS terminal 20. Additionally, the alternative device guidance information is information for guiding the customer to an alternative device (another self-POS terminal 20) capable of continuously executing the process being executed by the self-POS terminal 20 in which the anomaly has occurred, through the self-POS terminal 20 in which the anomaly has occurred. Additionally, as will be described later, when the store server 12 selects the self-POS terminal 20 as an alternative self-POS terminal 20, the communication interface 43 receives on-going status information and settlement condition information from the store server 12. Here, the on-going status information is information indicating the on-going status of the process being executed by the self-POS terminal 20 in which the anomaly has occurred. Additionally, the settlement condition information is information indicating settlement conditions such as a payment method and the form of a receipt to be issued, which are selected by the customer through a selection screen (see FIG. 7) to be described later, in the self-POS terminal 20 in which the anomaly has occurred. Additionally, each time a new commodity is registered, the communication interface 43 further transmits the commodity registration file Fb to the store server 12. Additionally, the communication interface 43 transmits information of the operating state of the self-POS terminal 20 itself to the store server 12. Here, the information of the operating state of the self-POS terminal 20 itself includes information of the process being executed by the self-POS terminal 20. The information of the process being executed includes, for example, information indicating that the self-POS terminal 20 is in a standby state, the registration process is being performed, the registration process is completed, the settlement process is being performed, and the settlement process is completed. Additionally, the information of the operating states of the respective functional parts of the self-POS terminal 20 is information indicating whether or not the self-POS terminal 20 is normally operating, and includes information indicating, for example, the hardware states of the functional parts such as the display device 281 and the touch panel 282, the fixed scanner 27, the handy scanner 31, the card reader and writer 29, the receipt printer 30, the cash depositing and dispensing device 26, and the weight sensors 220 and 230. Further, the information of the operating states of the respective functional parts includes, for example, information indicating the remaining amount of receipt sheets in the receipt printer 30, and the remaining number of coins for change and the remaining number of bills for change in the cash depositing and dispensing device 26. Additionally, when it is confirmed that an anomaly has occurred in the self-POS terminal 20 upon receiving the anomaly occurrence information, the communication interface 43 transmits the settlement condition information to the store server 12.

### Description on Hardware Configuration of Store Server

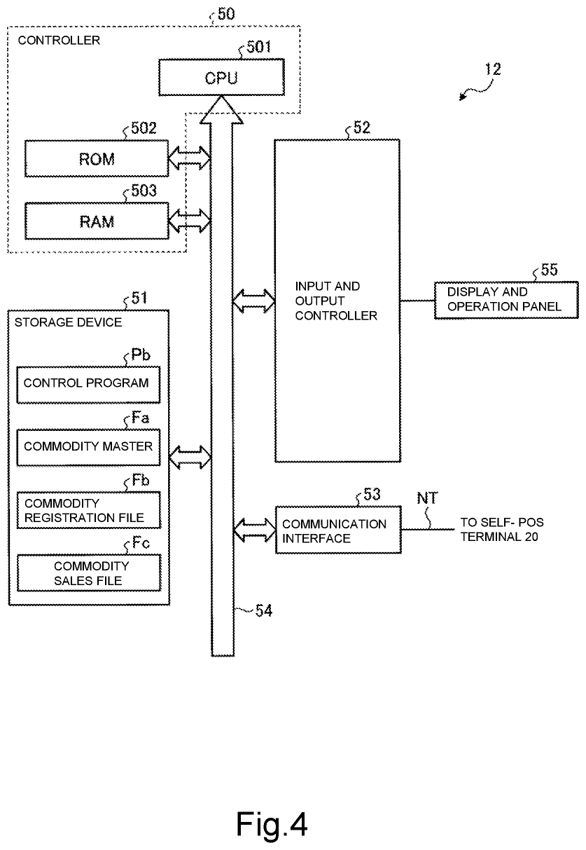

A hardware configuration of the store server 12 will be described with reference to FIG. 4. FIG. 4 is a hardware block diagram showing an example of the hardware configuration of the store server.

The store server 12 includes a controller 50, a storage device 51, an input and output controller 52, and a communication interface 53.

The controller 50 includes a CPU 501, a ROM 502, and a RAM 503. The CPU 501 is a control subject. The ROM 502 stores various kinds of fixed data, various tables, and the like. The RAM 503 functions as a work memory for expanding a control program and various kinds of data when the CPU 501 performs various processes.

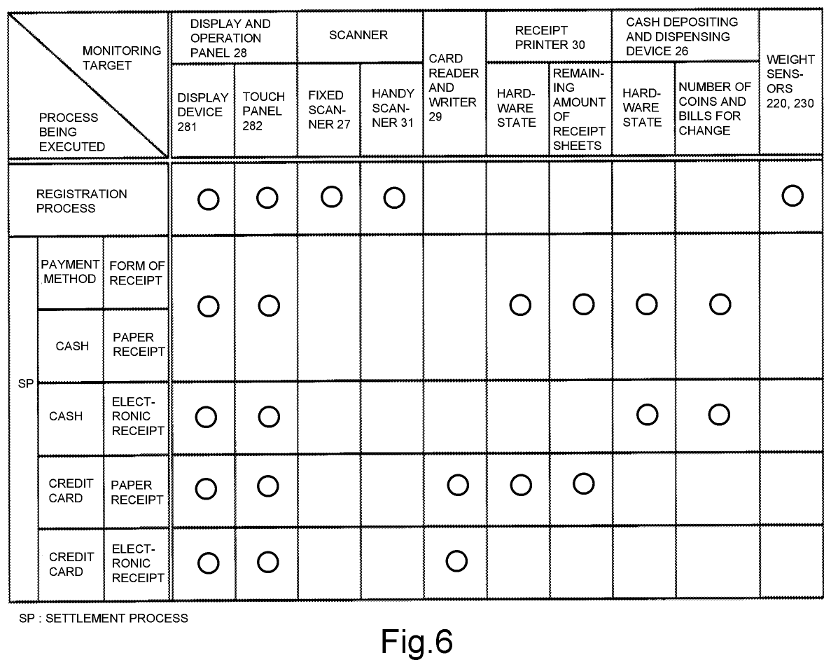

The storage device 51 stores a control program Pb, a commodity master Fa, a commodity registration file Fb, and a commodity sales file Fc. Additionally, the storage device 51 stores, for example, a correspondence relationship (see FIG. 6) between each of the processes (the registration process and the settlement process) executed by the self-POS terminal 20, which will be described later, and a functional part to be monitored of the self-POS terminal 20. The storage device 51 is, for example, an HDD that holds stored information even when the power is turned off. Additionally, the storage device 51 may include a nonvolatile memory such as a flash memory, instead of the HDD.

The control program Pb is a program executed by the CPU 501. The CPU 501, the ROM 502, the RAM 503, and the storage device 51 are connected to one another via an internal bus 54. The CPU 501 of the controller 50 expands, in the RAM 503, the control program Pb stored in the storage device 51 and various kinds of data stored in the ROM 502 to operate the control program Pb. As a result, the controller 50 executes various control processes performed by the store server 12.

The details of the commodity master Fa, the commodity registration file Fb, and the commodity sales file Fc stored in the storage device 51 are the same as those of the commodity master Fa, the commodity registration file Fb, and the commodity sales file Fc stored in the storage device 41 described above.

Note that the commodity registration file Fb stored in the storage device 51 is a file updated each time a commodity to be purchased by the customer is registered in each self-POS terminal 20, and then transmitted from the self-POS terminal 20 to the store server 12. The commodity registration file Fb is transmitted from the self-POS terminal 20 to the store server 12 together with information for specifying the self-POS terminal 20 for which the commodity registration file Fb is generated.

Additionally, the commodity sales file Fc stored in the storage device 51 is a file generated each time the self-POS terminal 20 completes a settlement process, and then transmitted from the self-POS terminal 20 to the store server 12. Additionally, the communication interface 53 connects the store server 12 and the self-POS terminal 20 to each other via a communication line NT. The communication interface 53 communicates with each self-POS terminal 20 under the control of the controller 50 and transmits and receives various kinds of information. For example, the communication interface 53 transmits the anomaly occurrence information and the alternative device guidance information to a self-POS terminal 20 in which an anomaly has occurred. Additionally, the communication interface 53 transmits the on-going status information and the settlement condition information of the self-POS terminal 20 in which the anomaly has occurred, to an alternative self-POS terminal 20. Additionally, for example, the communication interface 53 receives the commodity registration file Fb from the self-POS terminal 20 each time a new commodity is registered in each self-POS terminal 20. Additionally, the communication interface 53 receives information of the process being executed by the self-POS terminal 20 and information of the operating state of each functional part and the like, as the information of the operating state of each self-POS terminal 20, from each self-POS terminal 20. Further, the communication interface 53 receives the settlement condition information from the self-POS terminal 20 in which the anomaly has occurred. Additionally, a display and operation panel 55 displays various kinds of information to an operator who operates the store server 12, and also receives an operation input by the operator.

### Description on Functional Configuration of Monitoring System

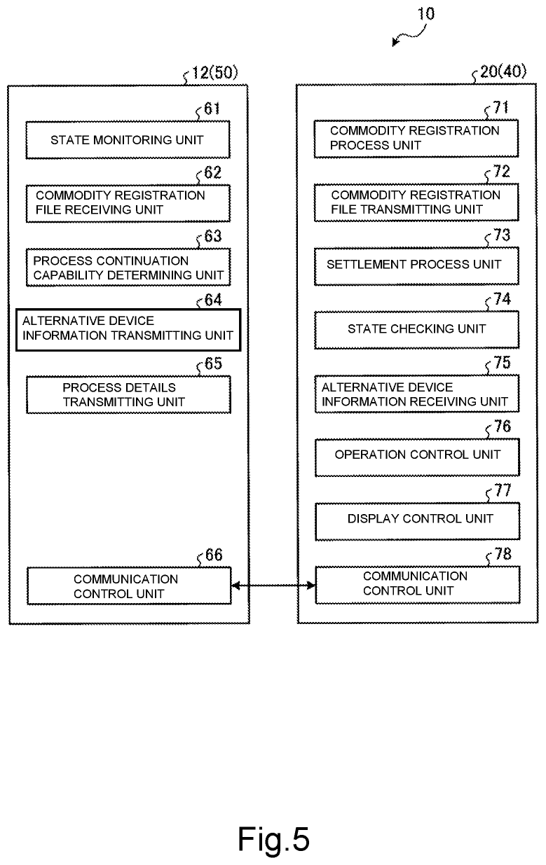

A functional configuration of the monitoring system 10 will be described with reference to FIG. 5. FIG. 5 is a functional block diagram showing an example of the functional configuration of the monitoring system according to the embodiment.

The controller 50 of the store server 12 (see FIG. 4) expands the control program Pb in the RAM 503 and operates the control program Pb, thus achieving a state monitoring unit 61, a commodity registration file receiving unit 62, a process continuation capability determining unit 63, an alternative device information transmitting unit 64, a process details transmitting unit 65, and a communication control unit 66 shown in FIG. 5 as functional parts.

The state monitoring unit 61 of the controller 50 monitors operating states of the plurality of self-POS terminals 20 (commodity sales data processing apparatuses). The state monitoring unit 61 then determines whether or not an anomaly has occurred in each self-POS terminal 20 on the basis of a result of the monitoring. Specifically, the state monitoring unit 61 acquires a result of the checking by a state checking unit 74 of each self-POS terminal 20 via the communication interface 53. Here, the result of the checking includes information of a process being executed by the self-POS terminal 20 and information of the operating state of each functional part checked by the state checking unit 74. As described above, the information of the process being executed is information indicating the states where the self-POS terminal 20 is in a standby state, a registration process is being performed, a settlement process is being performed, and the like. As described above, the information of the operating state of each functional part includes, for example, the information of the hardware state of the functional part. The state monitoring unit 61 monitors the operating state of the self-POS terminal 20 in accordance with the correspondence relationship (see FIG. 6) between the process being executed by the self-POS terminal 20 and the functional part, which will be described later, with the acquired result of the checking as a monitoring target. Note that, as described above, when the functional part is the cash depositing and dispensing device 26, the information of the operating state of the functional part includes not only the information of the hardware state but also the information of the remaining number of coins for change and the remaining number of bills for change. Additionally, as described above, when the functional part is the receipt printer 30, the information of the operating state of the functional part includes not only the information of the hardware state but also the information of the remaining amount of receipt sheets. Additionally, when determining that an anomaly has occurred in the self-POS terminal 20 on the basis of the result of the monitoring, the state monitoring unit 61 instructs the communication control unit 66 to transmit anomaly occurrence information to the self-POS terminal 20 in which the anomaly has occurred.

The commodity registration file receiving unit 62 of the controller 50 acquires the commodity registration file Fb from the self-POS terminal 20 via the communication interface 53 controlled by the communication control unit 66, each time a new commodity is registered in each self-POS terminal 20.

When an anomaly has occurred in the operating state of the self-POS terminal 20 (commodity sales data processing apparatus), the process continuation capability determining unit 63 of the controller 50 further determines, on the basis of the result of the monitoring by the state monitoring unit 61, whether or not another self-POS terminal 20 is capable of executing at least the process being executed by the self-POS terminal 20 in which the anomaly has occurred. Note that the process continuation capability determining unit 63 determines whether or not another self-POS terminal 20 is capable of executing not only the process being executed by the self-POS terminal 20 in which the anomaly has occurred (e.g., registration process) but also a process to be performed subsequently to the process being executed (e.g., settlement process).

The alternative device information transmitting unit 64 of the controller 50 instructs the communication control unit 66 to transmit the alternative device guidance information to the self-POS terminal 20 in which the anomaly has occurred, on the basis of a result of the determination by the process continuation capability determining unit 63. As described above, the alternative device guidance information is information for guiding the customer to another self-POS terminal 20 (alternative self-POS terminal 20) capable of continuously executing the process being performed by the self-POS terminal 20 in which the anomaly has occurred, through the self-POS terminal 20 in which the anomaly has occurred. Note that the alternative device information transmitting unit 64 is an example of an alternative device guiding unit.

The process details transmitting unit 65 of the controller 50 instructs the communication control unit 66 to transmit the on-going status information to the alternative self-POS terminal 20 guided by the alternative device information transmitting unit 64, on the basis of the result of the monitoring by the state monitoring unit 61, for example. Note that, as described above, the on-going status information is the information indicating the on-going status of the process being executed by the self-POS terminal 20 in which the abnormal has occurred. Additionally, the process details transmitting unit 65 instructs the communication control unit 66 to transmit the settlement condition information (information such as a payment method and the form of a receipt to be issued) selected by the customer in the self-POS terminal 20 in which the abnormal has occurred, to the alternative self-POS terminal 20 guided by the alternative device information transmitting unit 64. Note that the process details transmitting unit 65 is an example of an on-going status transmitting unit.

The communication control unit 66 of the controller 50 performs communication between the store server 12 and the plurality of self-POS terminals 20 by controlling the communication interface 53 in accordance with the instructions of the state monitoring unit 61, the alternative device information transmitting unit 64, the process details transmitting unit 65, and the like, and transmits and receives various kinds of information. For example, the communication control unit 66 causes the communication interface 53 to transmit the anomaly occurrence information to the self-POS terminal 20 in which the anomaly has occurred, in response to the instruction of the state monitoring unit 61. For example, the communication control unit 66 causes the communication interface 53 to transmit the alternative device guidance information to the self-POS terminal 20 in which the anomaly has occurred, in response to the instruction of the process continuation capability determining unit 63. For example, the communication control unit 66 causes the communication interface 53 to transmit the on-going status information to the alternative self-POS terminal 20 in response to the instruction of the process details transmitting unit 65. Further, for example, the communication control unit 66 causes the communication interface 53 to transmit the settlement condition information selected by the customer in the self-POS terminal 20 in which the anomaly has occurred, to the alternative self-POS terminal 20 in response to the instruction of the process details transmitting unit 65. Additionally, for example, the communication control unit 66 causes the communication interface 53 to receive the commodity registration file Fb from each self-POS terminal 20. Additionally, the communication control unit 66 causes the communication interface 53 to receive, from the self-POS terminal 20 in which the anomaly has occurred, the settlement condition information selected by the customer in that self-POS terminal 20. Additionally, the communication control unit 66 causes the communication interface 53 to receive, from each self-POS terminal 20, the information of the process being executed and the information of the operating state of each functional part or the like (a result of the checking by the state checking unit 74) as the information of the operating state of the self-POS terminal 20.

Additionally, as shown in FIG. 5, the controller 40 of the self-POS terminal 20 (see FIG. 3) expands the control program Pa in the RAM 403 and operates the control program Pa, thus achieving a commodity registration process unit 71, a commodity registration file transmitting unit 72, a settlement process unit 73, the state checking unit 74, an alternative device information receiving unit 75, an operation control unit 76, a display control unit 77, and a communication control unit 78 shown in FIG. 5 as functional parts.

The commodity registration process unit 71 of the controller 40 performs a registration process of registering data of a commodity to be purchased by the customer. Specifically, the commodity registration process unit 71 registers the data of the commodity to be purchased by the customer in the commodity registration file Fb by collating the commodity code recorded in the code symbol read by the fixed scanner 27 or the handy scanner 31 with the commodity master Fa.

The commodity registration file transmitting unit 72 of the controller 40 instructs the communication control unit 78 to transmit the commodity registration file Fb to the store server 12 together with the information for specifying the self-POS terminal 20 as the transmission source, each time the data of the commodity registered by the commodity registration process unit 71 is registered (written) in the commodity registration file Fb.

The settlement process unit 73 of the controller 40 receives a payment from the customer by a payment method (for example, payment in cash, payment using a credit card, payment using electronic money, or the like) designated in advance by the customer for the commodity registered by the commodity registration process unit 71, and performs a settlement process of issuing a receipt in the form of a receipt (paper receipt, electronic receipt, or the like) designated in advance by the customer.

The state checking unit 74 of the controller 40 checks the operating states of the respective functional parts of the self-POS terminal 20. As described above, the operating states of the respective functional parts include the hardware state of each functional part, the remaining amount of receipt sheets, the remaining number of coins for change, the remaining number of bills for change, and the like. The state checking unit 74 instructs the communication control unit 78 to transmit the checked operating states of the respective functional parts of the self-POS terminal 20 to the store server 12. Additionally, the state checking unit 74 checks whether or not the anomaly occurrence information has been received from the store server 12 by the communication interface 43 controlled by the communication control unit 78. As described above, the anomaly occurrence information is information indicating that the operating state of the self-POS terminal 20 itself is abnormal.

The alternative device information receiving unit 75 of the controller 40 acquires the alternative device guidance information for guiding the customer to an alternative device (alternative self-POS terminal 20) capable of continuing the process from the store server 12 via the communication interface 43 controlled by the communication control unit 78.

The operation control unit 76 of the controller 40 acquires the operation details performed by the customer. The controller 40 then performs processes corresponding to the operation details. For example, the operation control unit 76 instructs the communication control unit 78 to transmit a settlement condition acquired through the selection screen (see FIG. 7), which will be described later, to the store server. Here, the settlement condition is information such as a payment method and the form of a receipt to be issued, which are selected by the customer.

The display control unit 77 of the controller 40 causes the display and operation panel 28 (display device 281) to display the display data. For example, when the state checking unit 74 confirms that the anomaly occurrence information has been received, the display control unit 77 causes the display device 281 to display the selection screen (see FIG. 7) to be described later.

The communication control unit 78 of the controller 40 performs communication between the self-POS terminal 20 and the store server 12 by controlling the communication interface 43, and transmits and receives various kinds of information. For example, the communication control unit 78 transmits the commodity registration file Fb to the store server 12 together with the information for specifying the self-POS terminal 20 as the transmission source in accordance with the instruction of the commodity registration file transmitting unit 72. For example, the communication control unit 78 transmits the result of the checking by the state checking unit 74, that is, the operating states of the respective functional parts of the self-POS terminal 20, to the store server 12 in accordance with the instruction of the state checking unit 74.

### Description on Functional Configuration of Monitoring System

Next, the functional part to be monitored of the self-POS terminal 20 monitored by the store server 12 will be described with reference to FIG. 6. FIG. 6 is a diagram showing an example of the correspondence relationship between a process executed by the self-POS terminal and a functional part of the self-POS terminal monitored by the store server in accordance with the process executed by the self-POS terminal. The correspondence relationship shown in FIG. 6 is stored in advance in the storage device 51, for example.

First, FIG. 6 shows a process (process being executed) performed by the self-POS terminal 20 when monitored by the store server 12 (controller 50). In the example of FIG. 6, the process being executed by the self-POS terminal 20 specifically includes a registration process of registering data of a commodity to be purchased by the customer, and a settlement process of performing a settlement on the basis of the registered data of the commodity. In particular, the settlement process includes a plurality of cases depending on a combination of a payment method (a payment in cash or a payment using a credit card) by the customer, the form of a receipt to be issued (whether a paper receipt is issued or an electronic receipt is issued), and the like. Although not shown in FIG. 6, the combination of the payment method by the customer and the form of a receipt to be issued at the time of the settlement process may also include a combination of a case of a payment using a prepaid card, a case of issuing both a paper receipt and an electronic receipt, and the like.

Additionally, FIG. 6 shows the functional parts to be monitored of the self-POS terminal 20 whose operating state is monitored by the state monitoring unit 61 of the controller 50 in accordance with the process being executed by the self-POS terminal 20. In the example of FIG. 6, the functional parts of the self-POS terminal 20 are specifically the display and operation panel 28 including the display device 281 and the touch panel 282, the scanners including the fixed scanner 27 and handy scanner 31, the card reader and writer 29, the receipt printer 30, the cash depositing and dispensing device 26, and the weight sensors. That is, the state monitoring unit 61 of the controller 50 monitors the functional parts corresponding to the process being executed by the self-POS terminal 20, as the functional parts to be monitored, in accordance with the correspondence relationship shown in FIG. 6. For example, if the process being executed by the self-POS terminal 20 is the registration process, the functional parts to be monitored of the self-POS terminal 20 corresponding to the registration process are the display and operation panel 28 (display device 281 and touch panel 282), the scanners (fixed scanner 27 and handy scanner 31), and the weight sensors 220 and 230, as indicated by the circles in FIG. 6. Additionally, for example, if the process being executed by the self-POS terminal 20 is the settlement process, and if the combination of the payment method and the form of a receipt at the time of the settlement, which are selected by the customer, is a combination of a payment in cash and a paper receipt, the functional parts to be monitored of the self-POS terminal 20 corresponding to the settlement process are the display device 281, the touch panel 282, the receipt printer 30, and the cash depositing and dispensing device 26, as indicated by the circles in FIG. 6. Additionally, for example, if the process being executed by the self-POS terminal 20 is the settlement process, and if the combination of the payment method and the form of a receipt at the time of the settlement, which are selected by the customer, is a combination of a payment in cash and an electronic receipt, the functional parts to be monitored of the self-POS terminal 20 corresponding to the settlement process are the display device 281, the touch panel 282, and the cash depositing and dispensing device 26, as indicated by the circles in FIG. 6. Additionally, for example, if the process being executed by the self-POS terminal 20 is the settlement process, and if the combination of the payment method and the form of a receipt at the time of the settlement, which are selected by the customer, is a combination of a payment using a credit card and a paper receipt, the functional parts to be monitored of the self-POS terminal 20 corresponding to the settlement process are the display device 281, the touch panel 282, the card reader and writer 29, and the receipt printer 30, as indicated by the circles in FIG. 6. Additionally, for example, if the process being executed by the self-POS terminal 20 is the settlement process, and if the combination of the payment method and the form of a receipt at the time of the settlement, which are selected by the customer, is a combination of a payment using a credit card and an electronic receipt, the functional parts to be monitored of the self-POS terminal 20 corresponding to the settlement process are the display device 281, the touch panel 282, and the card reader and writer 29, as indicated by the circles in FIG. 6. Additionally, in the example of FIG. 6, the display and operation panel 28, the scanners 27 and 31, the card reader and writer 29, and the weight sensors 220 and 230 are monitored for their operating states, for example, their hardware states. Additionally, the receipt printer 30 is monitored for its operating state, for example, its hardware state and the remaining amount of receipt sheets. Additionally, the cash depositing and dispensing device 26 is monitored for its operating state, for example, its hardware state, the remaining number of coins for change, and the remaining number of bills for change.

The state monitoring unit 61 of the controller 50 monitors, for all of the plurality of self-POS terminals 20, at least the operating states of the functional parts corresponding to the process (registration process or settlement process) being executed by the self-POS terminal 20 being operated by the customer, in accordance with the correspondence relationship shown in FIG. 6. The state monitoring unit 61 then determines whether or not the operating state of each functional part being operated by the customer is abnormal. For example, when the registration process is performed in a certain self-POS terminal 20, the self-POS terminal 20 transmits, to the store server 12, information indicating that the registration process is being executed. At that time, the state monitoring unit 61 of the controller 50 of the store server 12 determines, for all of the plurality of self-POS terminals 20, whether or not at least the operating states of the functional parts corresponding to or related to the registration process being executed by the self-POS terminal 20 being operated, that is, the display device 281, the touch panel 282, the fixed scanner 27, the handy scanner 31, and the weight sensors 220 and 230 are abnormal, in accordance with the correspondence relationship shown in FIG. 6. Note that the result of the determination by the state monitoring unit 61 is also used in the determination by the process continuation capability determining unit 63, for example. In this case, for example, it is desirable for another self-POS terminal 20 (alternative self-POS terminal 20), which is determined to be capable of continuously executing the registration process and then guided, to execute the remaining process to the end. Therefore, it is desirable for the state monitoring unit 61 to determine whether or not the operating states of the functional parts corresponding to not only the registration process (process being executed) but also the settlement process (process to be executed next) are abnormal.

Additionally, when the settlement process is performed in a certain self-POS terminal 20, the self-POS terminal 20 transmits, to the store server 12, information indicating that the settlement process is being performed. At that time, the state monitoring unit 61 of the controller 50 of the store server 12 determines, for all of the plurality of self-POS terminals 20, whether or not the operating states of the functional parts corresponding to the settlement process being executed by the self-POS terminal 20 being operated, that is, the display device 281, the touch panel 282, the card reader and writer 29, the receipt printer 30, and the cash depositing and dispensing device 26 are abnormal, in accordance with the correspondence relationship shown in FIG. 6.

Note that when the registration process is completed and when an anomaly occurs in the self-POS terminal 20 during the registration process, the self-POS terminal 20 prompts the customer to designate the conditions of the settlement process by, for example, presenting the screen shown in FIG. 7 to the customer. The designated information is transmitted from the self-POS terminal 20 to the store server 12. The designated information is then used when the state monitoring unit 61 of the controller 50 of the store server 12 selects a functional part to be monitored. That is, in accordance with the correspondence relationship shown in FIG. 6, the state monitoring unit 61 is capable of limiting the functional parts, for which the operating states are to be monitored and the anomalies are to be determined, depending on the payment method and the form of a receipt to be issued. Note that FIG. 7 is a diagram showing an example of a screen on which the customer designates a condition when the settlement process is performed by the self-POS terminal.

Note that, since the plurality of self-POS terminals 20 are installed, the self-POS terminal 20 performing the registration process and the self-POS terminal 20 performing the settlement process are generally mixed. Thus, the store server 12 of the embodiment generally monitors all the functional parts that need to be monitored.

Referring back to FIG. 7, a cash payment selection button Ba, a credit card payment selection button Bb, a paper receipt selection button Bc, an electronic receipt selection button Bd, and a decision button Be are displayed on the screen for selecting the settlement conditions displayed on the display device 281.

The customer presses one of the cash payment selection button Ba and the credit card payment selection button Bb for selection. Additionally, the customer presses one of the paper receipt selection button Bc and the electronic receipt selection button Bd for selection. Subsequently, the customer determines the selection by pressing the decision button Be. That is, before the decision button Be is pressed, the selected state at that time can be changed. For example, when the credit card payment selection button Bb is pressed in a state where the cash payment selection button Ba is selected, the selection of the cash payment selection button Ba is rejected, and the state shifts to a state where a payment using a credit card is selected. The same applies to the selection for the form of a receipt.

Note that an electronic money payment selection button or the like may be prepared in addition to the cash payment selection button Ba and the credit card payment selection button Bb. Additionally, a selection button for selecting the issuance of a receipt other than the paper receipt selection button Bc and the electronic receipt selection button Bd may be prepared.

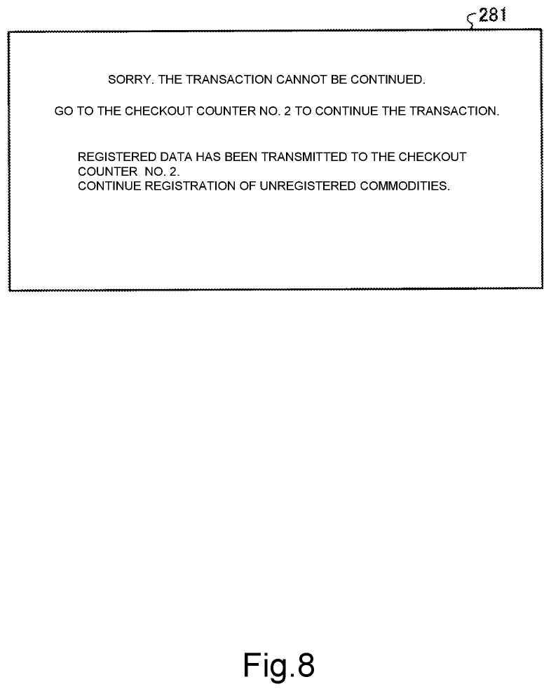

FIG. 8 is a diagram showing an example of an alternative device guidance screen. That is, FIG. 8 is an example of a screen displayed on the display device 281 when an anomaly occurs in the self-POS terminal 20 being used while the customer is performing the commodity registration, and when the self-POS terminal 20 fails to continue the commodity registration.

At that time, since the information of the commodities for which the registration has been completed has already been transmitted to the commodity registration file Fb stored in the store server 12, the customer moves to a designated self-POS terminal 20 (alternative self-POS terminal 20) while holding the basket, which is placed on the first placement table 22 and contains unregistered commodities, and the take-out bag, which is placed on the second placement table 23 and contains the registered commodities. The customer then continues inputting the data of unregistered commodities contained in the basket, in the self-POS terminal 20 of the moving destination.

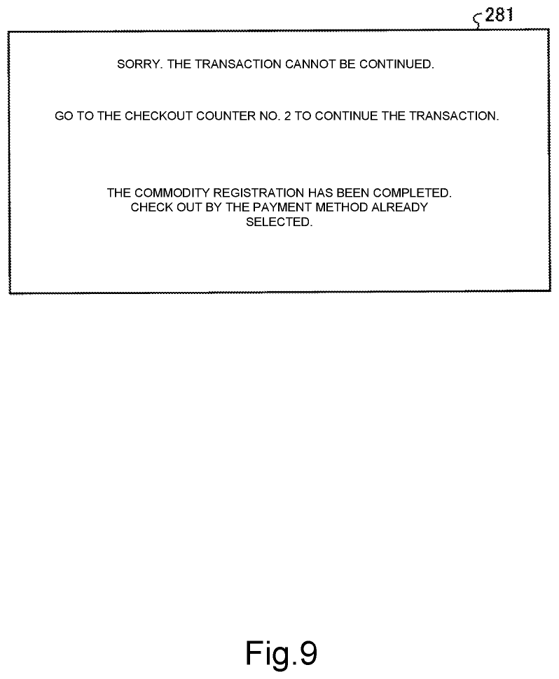

FIG. 9 is a diagram showing another example of the alternative device guidance screen. That is, FIG. 9 is an example of a screen displayed on the display device 281 when an anomaly occurs in the self-POS terminal 20 being used while the customer is performing the settlement process after the completion of the commodity registration, and when the self-POS terminal 20 fails to continue the settlement process.

At that time, since the information of all the registered commodities has already been transmitted to the commodity registration file Fb stored in the store server 12, the customer moves to a designated self-POS terminal 20 (alternative self-POS terminal 20) while holding the take-out bag, which is placed on the second placement table 23 and contains all the registered commodities. The customer then performs the settlement process by the selected method in the self-POS terminal 20 of the moving destination.

### Description on Process Flow Performed by Monitoring System

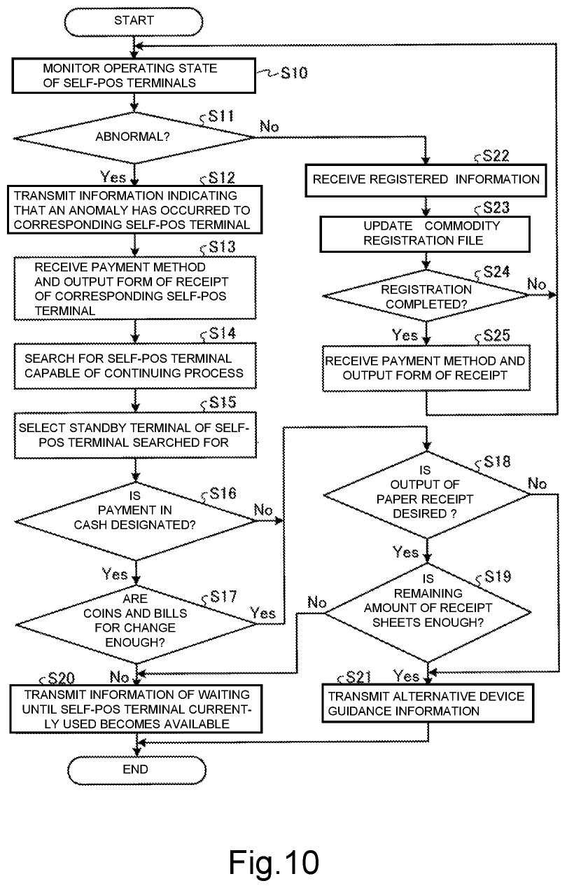

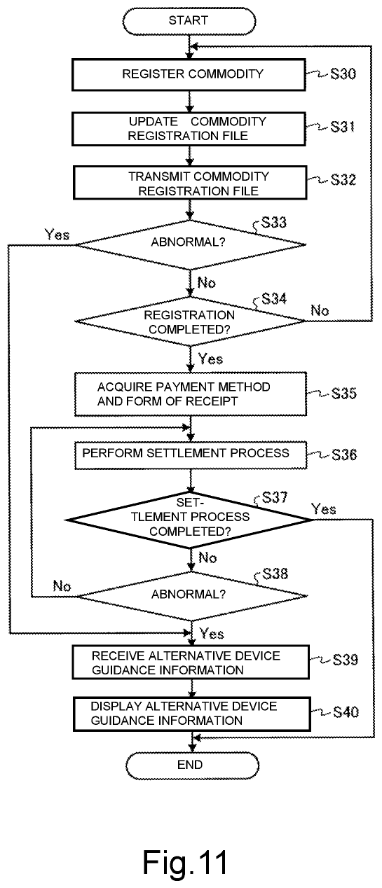

Next, the process performed by the monitoring system 10 will be described with reference to FIGS. 10 and 11. FIG. 10 is a flowchart showing an example of the process performed by the controller 50 of the store server 12. FIG. 11 is a flowchart showing an example of the process performed by the controller 40 of the self-POS terminal 20.

First, the process performed by the controller 50 of the store server 12 will be described with reference to FIG. 10. In Step S10 of FIG. 10, the state monitoring unit 61 of the controller 50 monitors the operating states of the plurality of self-POS terminals 20.

Next, in Step S11, the state monitoring unit 61 of the controller 50 determines whether or not the operating state of each part of the self-POS terminal 20 is abnormal. If it is determined that the operating state of a part of the self-POS terminal 20 is abnormal (Step S11: YES), the process of the controller 50 proceeds to Step S12. On the other hand, if it is determined that the operating state of each part of the self-POS terminal 20 is not abnormal (Step S11: No), the process of the controller 50 proceeds to Step S22.

If it is determined in Step S11 that the operating state of a part of the self-POS terminal 20 is abnormal, in Step S12, the process continuation capability determining unit 63 of the controller 50 transmits anomaly occurrence information indicating that an anomaly has occurred to the self-POS terminal 20 in which the anomaly has occurred, via the communication interface 53.

Next, in Step S13, the process continuation capability determining unit 63 of the controller 50 receives, via the communication interface 53, the payment method and the form of a receipt at the time of settlement, which are selected by the customer, from the self-POS terminal 20 in which the anomaly has occurred.

Subsequently, in Step S14, the process continuation capability determining unit 63 of the controller 50 searches for another self-POS terminal 20 capable of continuing the process being executed by the self-POS terminal 20 in which the anomaly has occurred, as an alternative self-POS terminal 20. Specifically, the process continuation capability determining unit 63 checks the operating states of the respective functional parts of the self-POS terminal 20 corresponding to the process being executed by the self-POS terminal 20 when the anomaly has occurred, the remaining amount of the receipt sheets, and the like on the basis of the results of the above-mentioned monitoring and determination performed by the state monitoring unit 61 in accordance with the correspondence relationship shown in FIG. 6, and searches for an alternative self-POS terminal 20.

Subsequently, in Step S15, the process continuation capability determining unit 63 of the controller 50 selects a standby self-POS terminal 20 (not currently used) from the alternative self-POS terminals 20 searched for.

Next, in Step S16, the process continuation capability determining unit 63 of the controller 50 determines whether or not the customer has selected a payment in cash as the payment method at the time of the settlement. If it is determined that the customer has selected a payment in cash (Step S16: YES), the process of the controller 50 proceeds to Step S17. On the other hand, if it is determined that the customer has not selected a payment in cash (Step S16: No), the process of the controller 50 proceeds to Step S18.

If it is determined in Step S16 that the customer has selected a payment in cash, in Step S17, the process continuation capability determining unit 63 determines whether or not the coins and bills for change are enough. Note that if the remaining numbers of coins and bills for change are larger than the preset numbers of coins and bills, respectively, it is determined that the coins and bills for change are enough. If it is determined that the remaining numbers of coins and bills for change are enough (Step S17: YES), the process of the controller 50 proceeds to Step S18. On the other hand, if it is determined that the remaining numbers of coins and bills for change are not enough (Step S17: No), the process of the controller 50 proceeds to Step S20.

If it is determined in Step S17 that the remaining numbers of coins and bills for change are not enough, in Step S20, the alternative device information transmitting unit 64 of the controller 50 transmits, to the self-POS terminal 20 in which the anomaly has occurred, information of waiting until any of the self-POS terminals 20 currently used becomes available. The controller 50 of the store server 12 then terminates the process of FIG. 10.

If it is determined in Step S16 that the customer has not selected a payment in cash, or if it is determined in Step S17 that the remaining numbers of coins and bills for change are enough, in Step S18, the process continuation capability determining unit 63 of the controller 50 determinates whether or not the customer wants the issuance of a paper receipt on the basis of the received information (see Step S13). If it is determined that the customer wants the output of a paper receipt (Step S18: YES), the process of the controller 50 proceeds to Step S19. On the other hand, if it is determined that the customer does not want the issuance of a paper receipt (Step S18: No), the process of the controller 50 proceeds to Step S21.

If it is determined in Step S18 that the customer wants the issuance of a paper receipt, in Step S19, the process continuation capability determining unit 63 determines whether or not the remaining amount of receipt sheets is enough. If it is determined that the remaining amount of receipt sheets is enough (Step S19: YES), the process of the controller 50 proceeds to Step S21. On the other hand, if it is determined that the remaining amount of receipt sheets is not enough (Step S19: No), the process of the controller 50 proceeds to Step S20. Note that whether or not the remaining amount of receipt sheets is enough is determined by, for example, a known means for measuring the remaining amount of receipt sheets using an optical sensor or the like.

If it is determined in Step S19 that the remaining amount of receipt sheets is enough, in Step S21, the alternative device information transmitting unit 64 outputs the alternative device guidance information for guiding the customer to another self-POS terminal 20 capable of continuing the process, to the self-POS terminal 20 in which the anomaly occurs. The controller 50 of the store server 12 then terminates the process of FIG. 10.

Note that the processes of Steps S16, S17, S18, and S19 are performed for all of the plurality of self-POS terminals 20 selected in Step S15. Therefore, the process continuation capability determining unit 63 of the controller 50 may select a plurality of self-POS terminals 20. In such a case, the controller 50 may guide the customer to all of the selected self-POS terminals 20 or may guide the customer to a self-POS terminal 20 closest to the self-POS terminal 20 in which the anomaly occurred, for example.

Next, returning to Step S11, if it is determined in Step S11 that the operating state of each part of the self-POS terminal 20 is not abnormal, in Step S22, the commodity registration file receiving unit 62 of the controller 50 receives the data of the registered commodity (commodity registration file Fb) from the self-POS terminal 20.

In Step S23, the commodity registration file receiving unit 62 of the controller 50 then stores the received data of the commodity (commodity registration file Fb) in the storage device 51 in association with the self-POS terminal 20 in which the data of the commodity is registered.

Next, in Step S24, the state monitoring unit 61 of the controller 50 determines whether or not the commodity registration has been completed in the self-POS terminal 20 being monitored. If it is determined that the commodity registration has been completed (Step S24: YES), the process of the controller 50 proceeds to Step S25. On the other hand, if it is determined that the commodity registration has not been completed (Step S24: No), the process of the controller 50 returns to Step S10. Note that whether or not the commodity registration has been completed can be determined on the basis of, for example, whether or not a subtotal key (not shown) has been operated.

If it is determined in Step S24 that the commodity registration has been completed, in Step S25, the state monitoring unit 61 of the controller 50 receives the payment method and the form of a receipt, which are selected by the customer, from the self-POS terminal 20. The process of the controller 50 then returns to Step S10.

Next, the process performed by the controller 40 of the self-POS terminal 20 will be described with reference to FIG. 11. In Step S30 of FIG. 11, the commodity registration process unit 71 of the controller 40 registers a commodity corresponding to the commodity code registered in the code symbol read by the fixed scanner 27 or the handy scanner 31.

Next, in Step S31, the commodity registration process unit 71 of the controller 40 updates the commodity registration file Fb by registering the data of the registered commodity in the commodity registration file Fb of the storage device 41.

Next, in Step S32, the commodity registration file transmitting unit 72 of the controller 40 transmits the commodity registration file Fb of the storage device 41 to the store server 12. Note that the commodity registration file transmitting unit 72 transmits the commodity registration file Fb to the store server 12 together with information for specifying the self-POS terminal 20 as the transmission source.

Next, in Step S33, the state checking unit 74 of the controller 40 determines whether or not the information indicating that the operating state of the self-POS terminal 20 itself is abnormal has been received from the store server 12. If it is determined that the information indicating that the operating state of the self-POS terminal 20 itself is abnormal has been received via the communication interface 43 (Step S33: YES), the process of the controller 40 proceeds to Step S39. On the other hand, if it is determined that the information indicating that the operating state of the self-POS terminal 20 itself is abnormal has not been received (Step S33: No), the process of the controller 40 proceeds to Step S34.

If it is determined in Step S33 that the information indicating that the operating state of the self-POS terminal 20 itself is abnormal has not been received, in Step S34, the commodity registration process unit 71 of the controller 40 determines whether or not the registration process for all the commodities has been completed. If it is determined that the registration process for all the commodities has been completed (Step S34: YES), the process of the controller 40 proceeds to Step S35. On the other hand, if it is not determined that the registration process for all the commodities has been completed (Step S34: No), the process of the controller 40 returns to Step S30. Note that whether or not the registration process for all the commodities has been completed is determined on the basis of, for example, whether or not a subtotal key (not shown) has been operated, as described above.

If it is determined in Step S34 that the registration process for all the commodities has been completed, in Step S35, the settlement process unit 73 of the controller 40 acquires the payment method and the form of a receipt to be output (see FIG. 7), which are acquired by the operation control unit 76 on the basis of the operation of the customer.

Subsequently, in Step S36, the settlement process unit 73 performs a settlement process.

Next, in Step S37, the settlement process unit 73 of the controller 40 determines whether or not the settlement process has been completed. If it is determined that the settlement process has been completed (Step S37: Yes), the self-POS terminal 20 terminates the process shown in FIG. 11. On the other hand, if it is determined that the settlement process has not been completed (Step S37: No), the process of the controller 40 proceeds to Step S38.

If it is determined in Step S37 that the settlement process has not been completed, in Step S38, the state checking unit 74 of the controller 40 determines whether or not the information indicating that the operating state of the self-POS terminal 20 itself is abnormal has been received from the store server 12. If it is determined that the information indicating that the operating state of the self-POS terminal 20 itself is abnormal has been received (Step S38: YES), the process of the controller 40 proceeds to Step S39. On the other hand, if it is determined that the information indicating that the operating state of the self-POS terminal 20 itself is abnormal has not been received (Step S38: No), the process of the controller 40 returns to Step S36.

If it is determined in Step S38 that information indicating that the operating state of the self-POS terminal 20 itself is abnormal has been received, or if it is determined in Step S33 that information indicating that the operating state of the self-POS terminal 20 itself is abnormal has been received, in Step S39, the alternative device information receiving unit 75 of the controller 40 receives, from the store server 12, alternative device guidance information for guiding the customer to an alternative self-POS terminal 20 capable of continuing the process.

Next, in Step S40, the display control unit 77 of the controller 40 displays the alternative device guide information for guiding the customer to the alternative self-POS terminal 20 on the display device 281. The controller 40 of the self-POS terminal 20 then terminates the process shown in FIG. 11.

As described above, in the store server 12 (information processing apparatus) of the embodiment, the state monitoring unit 61 of the controller 50 monitors the operating states of the plurality of self-POS terminals 20 (commodity sales data processing apparatuses). Additionally, when the operating state of the self-POS terminal 20 is abnormal, the process continuation capability determining unit 63 of the controller 50 determines whether or not another self-POS terminal 20 is capable of executing at least the process being executed by the self-POS terminal 20 in which the anomaly has occurred. The alternative device information transmitting unit 64 (alternative device guiding unit) of the controller 50 then transmits alternative device guidance information for guiding the customer to another self-POS terminal 20 (alternative self-POS terminal 20) capable of continuing the process, to the self-POS terminal 20 in which the anomaly has occurred, on the basis of the result of the determination by the process continuation capability determining unit 63. Therefore, when an anomaly such as a failure occurs in the self-POS terminal 20 being used by the customer, the process being performed by the customer can be taken over by another self-POS terminal 20 (alternative self-POS terminal 20).

Additionally, in the store server 12 (information processing apparatus) of the embodiment, the process continuation capability determining unit 63 of the controller 50 determines whether or not the process being executed by the self-POS terminal 20 in which the anomaly has occurred (commodity sales data processing apparatus) and a process to be executed subsequently to the process being executed are executable. Therefore, it is possible to guide the customer to an alternative device capable of executing the remaining process (the process to be executed subsequently to the process being executed) to the end.

Additionally, in the store server 12 (information processing apparatus) of the embodiment, the process continuation capability determining unit 63 of the controller 50 determines whether or not the process can be continued in a standby self-POS terminal 20 among the plurality of self-POS terminals 20 (commodity sales data processing apparatuses). Therefore, it is possible to guide the customer to an alternative device (alternative self-POS terminal 20) capable of continuing the process without a waiting time.

Additionally, in the store server 12 (information processing apparatus) of the embodiment, the process details transmitting unit 65 (on-going status transmitting unit) of the controller 50 transmits the on-going status of the process being executed by the self-POS terminal 20 (commodity sales data processing apparatus) in which the anomaly has occurred, to a self-POS terminal 20 (alternative self-POS terminal 20) guided by the alternative device information transmitting unit 64 (alternative device guiding unit). Therefore, for example, the registered commodity information is transmitted to the alternative device (alternative self-POS terminal 20) in succession, and thus the alternative device does not need to re-register all the commodities.

Additionally, the monitoring system 10 (information processing system) of the embodiment includes the store server 12 (information processing apparatus) and the self-POS terminals 20 (commodity sales data processing apparatuses) that each perform the registration process of registering data of a commodity to be purchased by the customer, and the settlement process of performing a settlement on the basis of the registered data of the commodity. The state monitoring unit 61 of the controller 50 of the store server 12 monitors the operating states of the plurality of self-POS terminals 20. Additionally, when the operating state of the self-POS terminal 20 is abnormal, the process continuation capability determining unit 63 of the controller 50 determines whether or not another self-POS terminal 20 is capable of executing at least the process being executed by the self-POS terminal 20 in which the anomaly has occurred. The alternative device information transmitting unit 64 (alternative device guiding unit) of the controller 50 then transmits the alternative device guidance information for guiding the customer to another self-POS terminal 20 (alternative self-POS terminal 20) capable of continuing the process, to the self-POS terminal 20 in which the anomaly has occurred, on the basis of the result of the determination by the process continuation capability determining unit 63. Therefore, when an anomaly such as a failure occurs in the self-POS terminal 20 being used by the customer, the process being performed by the customer can be taken over by another self-POS terminal 20 (alternative self-POS terminal 20).

Note that the embodiment is also applicable not only to the self-POS terminal 20 but also to a checkout device of a semi-self-POS terminal. That is, the semi-self-POS terminal includes a registering device with which a store clerk registers a commodity to be purchased by a customer, and a plurality of checkout devices with which the customer makes a payment on the basis of the registered commodity data. When an anomaly occurs in a checkout device, the embodiment can be applied so as to guide the customer to another checkout device (alternative checkout device) capable of continuing the checkout process of the checkout device.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus, which monitors operating states of a plurality of commodity sales data processing apparatuses, each of the plurality of commodity sales data processing apparatuses performing a plurality of processes on a basis of data of a commodity to be purchased, the data being to be input by a customer, the information processing apparatus comprising:
a communication interface that communicates with the plurality of commodity sales data processing apparatuses;
a storage device that stores a correspondence relationship between each of the plurality of processes executed by each of the plurality of commodity sales data processing apparatuses and a functional part to be monitored of a corresponding one of the plurality of commodity sales data processing apparatuses, the functional part corresponding to each of the plurality of processes; and
a controller that
acquires information of the plurality of processes being executed by the plurality of commodity sales data processing apparatuses and information of operating states of the functional parts from the plurality of commodity sales data processing apparatuses via the communication interface,
monitors the acquired operating states of the functional parts of the plurality of commodity sales data processing apparatuses in accordance with the correspondence relationship stored in the storage device,
determines, when determining that an anomaly has occurred in one of the plurality of commodity sales data processing apparatuses on a basis of a result of the monitoring, whether or not another one of the plurality of commodity sales data processing apparatuses is capable of executing at least a process being executed by the commodity sales data processing apparatus in which the anomaly has occurred, further on a basis of the result of the monitoring, and
transmits, on a basis of a result of the determination, information for guiding the customer to the other commodity sales data processing apparatus that is capable of executing the process being executed and serves as an alternative device, to the commodity sales data processing apparatus in which the anomaly has occurred, via the communication interface.

2. The information processing apparatus according to claim 1, wherein
the controller determines whether or not the other commodity sales data processing apparatus is capable of executing the process being executed by the commodity sales data processing apparatus in which the anomaly has occurred and a process to be performed subsequently to the process being executed.

3. The information processing apparatus according to claim 1, wherein
the controller determines whether or not a standby commodity sales data processing apparatus of the plurality of commodity sales data processing apparatuses is capable of executing the process being executed.

4. The information processing apparatus according to claim 1, wherein
the controller transmits an on-going status of the process being executed by the commodity sales data processing apparatus in which the anomaly has occurred, to the other commodity sales data processing apparatus serving as the alternative device, via the communication interface.

5. An information processing system, comprising:
a plurality of commodity sales data processing apparatuses that each perform
a registration process of registering data of a commodity to be purchased on a basis of the data of the commodity to be purchased, the data being to be input by a customer, and
a settlement process for the commodity to be purchased, on a basis of a result of the registration process; and
an information processing apparatus that monitors operating states of the plurality of commodity sales data processing apparatuses, wherein
the information processing apparatus includes
a first communication interface that communicates with the plurality of commodity sales data processing apparatuses,
a storage device that stores a correspondence relationship between each of the registration process and the settlement process executed by each of the plurality of commodity sales data processing apparatuses, and a functional part to be monitored of a corresponding one of the plurality of commodity sales data processing apparatuses, the functional part corresponding to each of the registration process and the settlement process, and
a first controller that
acquires information of the registration process or settlement process being executed by each of the plurality of commodity sales data processing apparatuses and information of an operating state of the functional part from each of the plurality of commodity sales data processing apparatuses via the first communication interface,
monitors the acquired operating states of the functional parts of the plurality of commodity sales data processing apparatuses in accordance with the correspondence relationship stored in the storage device,
determines, when determining that an anomaly has occurred in one of the plurality of commodity sales data processing apparatuses on a basis of a result of the monitoring, whether or not another one of the plurality of commodity sales data processing apparatuses is capable of executing at least the registration process or settlement process being executed by the commodity sales data processing apparatus in which the anomaly has occurred, further on a basis of the result of the monitoring, and
transmits, on a basis of a result of the determination, information for guiding the customer to the other commodity sales data processing apparatus that is capable of executing the registration process or settlement process being executed and serves as an alternative device, to the commodity sales data processing apparatus in which the anomaly has occurred, via the first communication interface.

6. The information processing system according to claim 5, wherein
each of the plurality of commodity sales data processing apparatuses includes
a second communication interface that communicates with the information processing apparatus,
a display device that display a guidance screen for the customer, and
a second controller that
checks the operating state of the commodity sales data processing apparatus,
transmits, as a result of the checking, information of the registration process or settlement process being executed by the commodity sales data processing apparatus, and the operating state of the functional part of the commodity sales data processing apparatus, to the information processing apparatus via the second communication interface, and
causes, when acquiring via the second communication interface the information for guiding the customer to the other commodity sales data processing apparatus serving as the alternative device, the display device to display the guidance screen for guiding the customer to the alternative device on a basis of the acquired information.

7. The information processing system according to claim 5, wherein
the first controller determines, when the process being executed by the commodity sales data processing apparatus in which the anomaly has occurred is the registration process, whether or not the other commodity sales data processing apparatus is capable of executing the registration process being executed and the settlement process to be performed subsequently to the registration process.

8. The information processing system according to claim 5, wherein
the first controller determines whether or not a standby commodity sales data processing apparatus of the plurality of commodity sales data processing apparatuses is capable of executing the registration process or settlement process being executed.

9. The information processing system according to claim 5, wherein
the first controller transmits an on-going status of the registration process or settlement process being executed by the commodity sales data processing apparatus in which the anomaly has occurred, to the other commodity sales data processing apparatus serving as the alternative device, via the first communication interface.

10. An information processing method for an information processing apparatus, which monitors operating states of a plurality of commodity sales data processing apparatuses, each of the plurality of commodity sales data processing apparatuses performing a plurality of processes on a basis of data of a commodity to be purchased, the data being to be input by a customer, the information processing method comprising:
storing, in a storage device in advance, a correspondence relationship between each of the plurality of processes executed by each of the plurality of commodity sales data processing apparatuses and a functional part to be monitored of a corresponding one of the plurality of commodity sales data processing apparatuses, the functional part corresponding to each of the plurality of processes;
acquiring information of the plurality of processes being executed by the plurality of commodity sales data processing apparatuses and information of operating states of the functional parts from the plurality of commodity sales data processing apparatuses via a communication interface;
monitoring the acquired operating states of the functional parts of the plurality of commodity sales data processing apparatuses in accordance with the correspondence relationship stored in the storage device;
determining, when determining that an anomaly has occurred in one of the plurality of commodity sales data processing apparatuses on a basis of a result of the monitoring, whether or not another one of the plurality of commodity sales data processing apparatuses is capable of executing at least a process being executed by the commodity sales data processing apparatus in which the anomaly has occurred, further on a basis of the result of the monitoring; and
transmitting, on a basis of a result of the determination, information for guiding the customer to the other commodity sales data processing apparatus that is capable of executing the process being executed and serves as an alternative device, to the commodity sales data processing apparatus in which the anomaly has occurred, via the communication interface.
